(19) United States
(12) Patent Application Publication
(10) Pub. No.: US 2025/0252444 A1
(43) Pub. Date: Aug. 7, 2025

(54) ADVANCED FRAUD DETECTION SYSTEM

(71) Applicant: Wells Fargo Bank, N.A., San Francisco, CA (US)

(72) Inventor: Ajit Gaddam, Danville, CA (US)

(21) Appl. No.: 19/046,068

(22) Filed: Feb. 5, 2025

Related U.S. Application Data
(60) Provisional application No. 63/551,025, filed on Feb. 7, 2024.

(51) Int. Cl. G06Q 20/40

(52) U.S. Cl. CPC G06Q 20/4016

(57) ABSTRACT

Systems and techniques may be used for detecting fraudulent interactions during a session by analyzing user behavior using a trained machine learning model. An example technique may include receiving transaction data including metadata related to a plurality of transactions with a plurality of accounts, identifying, using the transaction data, a subset of transactions of the plurality of transactions that trigger at least one suspect condition, and determining, from respective metadata of the subset of transactions, at least one related feature of a portion of the subset of transactions. The example technique may include generating a graph of the portion of the subset of transactions based on the at least one related feature, the graph identifying respective accounts of the plurality of accounts corresponding to the subset of transactions, and outputting the graph for display.

### CLAIM OF PRIORITY

This application claims the benefit of priority to U.S. Provisional Application No. 63/551,025 filed Feb. 7, 2024, titled “ADVANCED FRAUD DETECTION SYSTEM,” which is hereby incorporated herein by reference in its entirety.

### BACKGROUND

Traditional fraud detection systems face difficulty in effectively addressing the evolving landscape of financial fraud. Current methods often rely on outdated technologies and singular approaches that are unable to keep pace with sophisticated fraud schemes. These limitations can lead to delays in identifying and responding to fraudulent activities.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for implementing fraud detection, in accordance with some examples.

FIGS. 2A-2B illustrate example graphs and rings for identifying fraud, in accordance with some examples.

FIG. 3 illustrates a machine learning engine for training and execution related to fraud detection, in accordance with some examples.

FIGS. 4A-4C illustrate example checks, in accordance with some examples.

FIG. 5 illustrates a flowchart showing a technique for graph-based anomaly detection, in accordance with some examples.

FIG. 6 illustrates generally an example of a block diagram of a machine upon which any one or more of the techniques discussed herein may perform, in accordance with some examples.

FIG. 7 illustrates a flowchart showing a technique for check fraud detection in accordance with some examples.

FIG. 8 illustrates a flowchart showing a technique for banking session fraud detection in accordance with some examples.

FIG. 9 illustrates a flowchart showing a technique for digital check signature fraud detection in accordance with some examples.

FIG. 10 illustrates a flowchart showing a technique for digital check signature fraud detection in accordance with some examples.

### DETAILED DESCRIPTION

The systems and techniques described herein may be used to detect fraud in financial transactions, such as banking transactions. This may be accomplished by analyzing transaction data to identify suspicious patterns or anomalies. The identified suspicious patterns or anomalies may then be used to generate an alert or to take other action, such as blocking the transaction or flagging the account for review.

An example technique may include receiving transaction data including metadata related to a plurality of transactions with a plurality of accounts. The example technique may include identifying a subset of transactions of the plurality of transactions that trigger at least one suspect condition. The example technique may include determining, from respective metadata of the subset of transactions, at least one related feature of a portion of the subset of transactions. The example technique may include generating a graph of the portion of the subset of transactions based on the at least one related feature. The example technique may include outputting the graph for display.

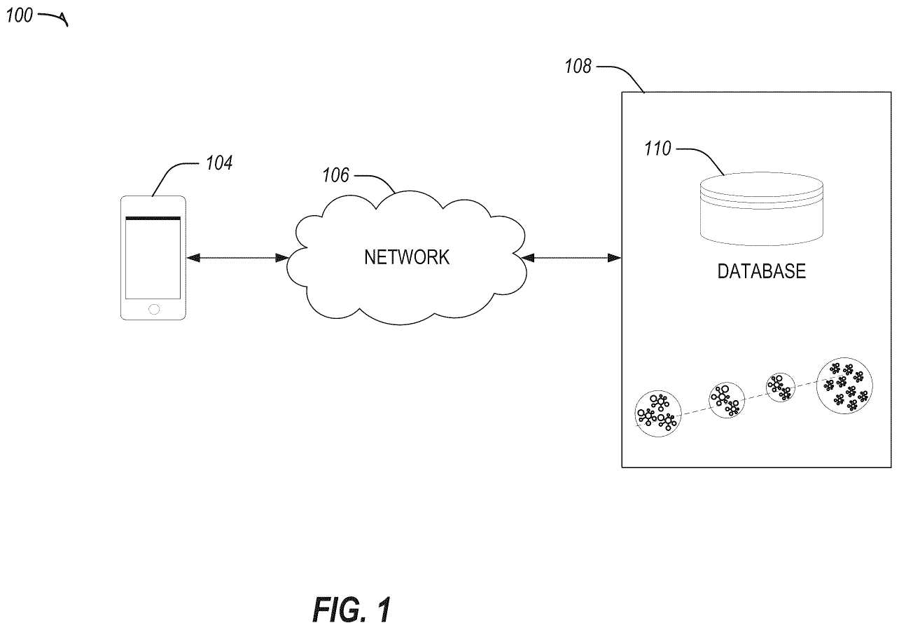

FIG. 1 illustrates a diagram showing components of a system 100 for implementing graph-based anomaly detection and related techniques for fraud detection, according to various examples. The system 100 includes a user device 104 (e.g., for capturing an image, such as of a check, for conducting transactions, for accessing a banking app or website, or the like). The user device 104 may communicate via a network 106 with a server 108 (e.g., a banking server, such as an authentication server, an app server, a fraud server, etc.), which may include or be communicatively coupled to a database 110. The server 108 may include or be configured as a banking server, such as an authentication server for verifying user credentials, an application server for processing user requests, or a fraud detection server for identifying suspicious activity. The database 110 may store transaction data, user account information, fraud detection models, or other relevant data.

The user device 104 may include a mobile phone, tablet, computer, or another computing device capable of interacting with the system. In an example, the user device 104 may capture an image of a check to initiate a remote deposit. The device may process the image to ensure it meets a required standard, such as clarity or orientation, before transmitting it to the server. The user device 104 may initiate a financial transaction, such as transferring funds or accessing an account through a banking application.

In another example, the user device 104 may detect an interaction, such as a mouse movement or touch input, during a session to identify a behavior that may indicate potential fraud, such as copying data from an external source. The user device 104 may act as an entry point for data into the system and may play a role in collecting and transmitting information.

The network 106 may facilitate communication between the user device 104 and the server 108. In some examples, the network 106 may include a wireless or wired communication channel, such as the internet, a cellular network, or a private banking network. For example, when the user device 104 captures an image of a check, the network 106 may transmit the image data from the user device 104 to the server 108 for processing. The network 106 may support an encrypted communication protocol to provide secure data transmission. In another example, the network 106 may enable real-time communication between the user device 104 and the server 108, allowing for a quick response to a potential fraud detected during a transaction.

The server 108 may be configured to analyze and process data received from the user device 104. In an example, the server 108 may perform fraud detection to evaluate transaction data against a stored fraud model to identify an anomaly. For example, when the user device 104 submits a check for deposit, the server 108 may verify the authenticity of the check by comparing features of the check with historical data stored in the database 110. In an example, the server 108 may include a machine learning engine that processes session data, such as a user interaction or a transaction history, to detect a behavioral pattern indicative of a potential fraud.

The database 110 may store a transaction record, a fraud detection model, user account information, or other relevant data. In an example, the database 110 may include an image of a previously processed check along with metadata, such as a date, amount, or signature. When the server 108 receives a new check image, the server 108 may query the database 110 to identify a matching record and detect a duplicate or counterfeit check. In another example, the database 110 may store a machine learning model trained on a historical transaction data set, allowing the server 108 to evaluate a current transaction for potential fraud. The database 110 may serve as a repository for data critical to the operation of the system 100.

In an example, the user device 104 may be used to capture an image of a check for remote deposit. The captured image may be transmitted through the network 106 to the server 108. The server 108 may analyze the image to extract details such as the payor, payee, or check amount. The database 110 may store this information. The server 108 may compare received data with one or more previously recorded transactions to identify potential anomalies or fraudulent activities. In another embodiment, the user device 104 may access a banking application to initiate a transaction. The server 108 may authenticate the user by cross-checking the transaction details with stored data in the database 110 to ensure validity.

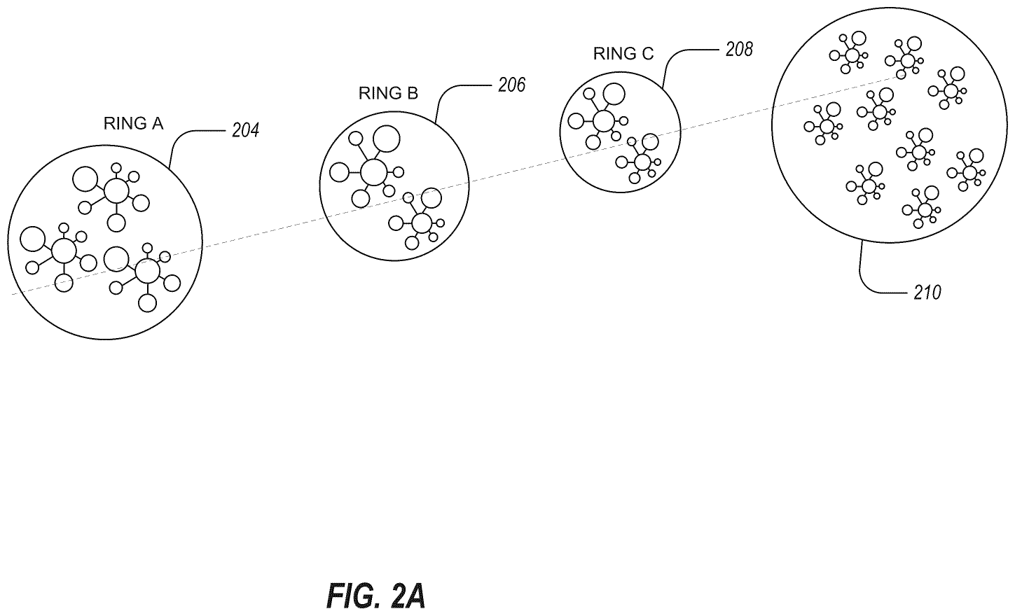

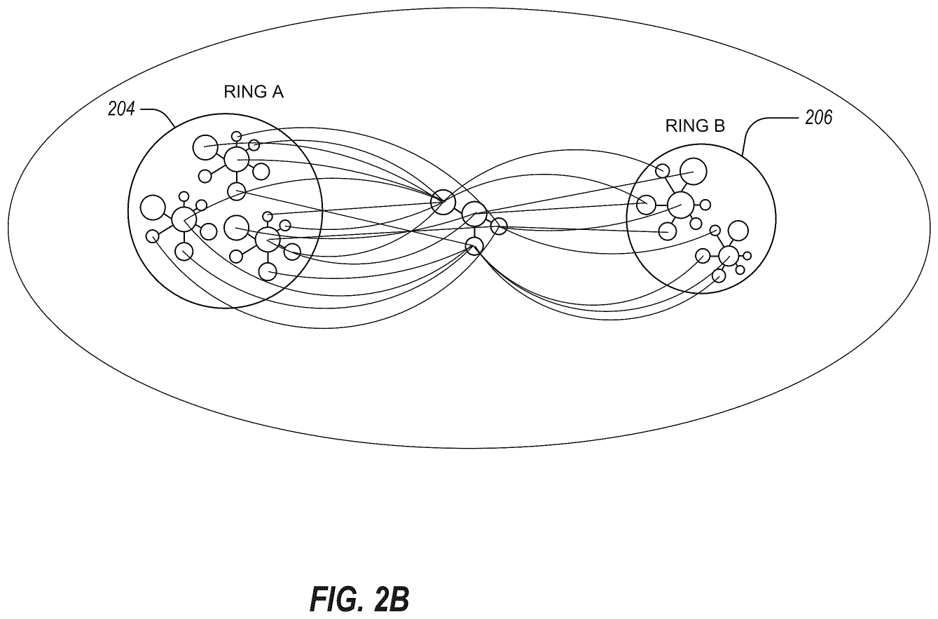

FIG. 2A illustrates examples graphs and rings for identifying fraud, according to various examples. The graphs depict relationships among accounts involved in activities some of which may include fraud. Examples of fraud may include sophisticated techniques that are not necessarily readily detectable and may involve mostly legitimate looking actions. For example, a large payment made to a credit card may be used to inflate a spending limit, followed by rapid use of the inflated credit and then returning the original large payment.

A cluster identified as Ring A 204 illustrates a graph showing data for accounts with charge-offs recorded during a period of time. Advanced analytics may be applied to this graph to identify clusters of accounts exhibiting suspicious behavior. For example, an analysis reveals a cluster, referred to as Ring A 204, which includes 51 accounts demonstrating a specific activity pattern. This pattern may involve excessive Zelle transfers exceeding $500, active Experian subscriptions, no recorded retail transactions, bill payments without payroll deposits, or similar traits. These details may indicate coordinated fraudulent activity.

A cluster identified as Ring B 206 illustrates a graph of a smaller cluster, which includes 15 accounts. This cluster may correspond to a different pattern, for example one with business account usage, bill payment activities, and higher credit card limits. For example, the accounts may be used to perform high-value transactions not associated with retail activity, which may suggest another form of coordinated fraud. In some examples, this smaller rings May be mapped from within a larger data set 210, which may include unreviewed accounts or accounts identified to not be fraudulent.

A cluster identified as Ring C 208 includes 5 accounts showing activity similar to Ring A 204 but with higher transaction values. For example, these accounts may be involved in wire transfers ranging from $10,000 to $30,000 originating from business accounts. The visual representation may be used to pinpoint additional relationships and patterns that distinguish this group from others, such as connections to specific business entities or high-value transactions.

FIG. 2B illustrates a new cluster formed from Ring A 204 and Ring B 206, after it is determined that they are connected. For example, in FIG. 2B, there are four nodes that connect Ring A 204 to Ring B 206. The four nodes may represent common attributes between the two clusters, such as physical address, IP address, WFA cookie, time of transaction, amount of transaction, etc. FIG. 2B illustrates another type of expansion of the clusters including additional accounts that were identified as potentially risky and having a shared attribute with one of the clusters. For example, an expansion of Ring B 206 may include additional new accounts. The new accounts may be reported for review at a corresponding line of business. The new connections (e.g., new accounts or between rings) is highlighted in the graph through nodes and edges representing shared attributes or transaction flows. After identifying the common nodes, Rings A and B 204 and 206 may be combined into a single larger ring. The subrings of Ring A 204 and Ring B 206 may be maintained for certain purposes, such as classifying or counting types of fraud, while the larger ring may be used to stop the fraud or identify the fraudsters.

In some examples, the information provided by the clusters may be further refined to calculate total losses associated with the identified accounts (e.g., by adding each account together within the cluster). The results of this analysis may be referred to law enforcement for investigation or action.

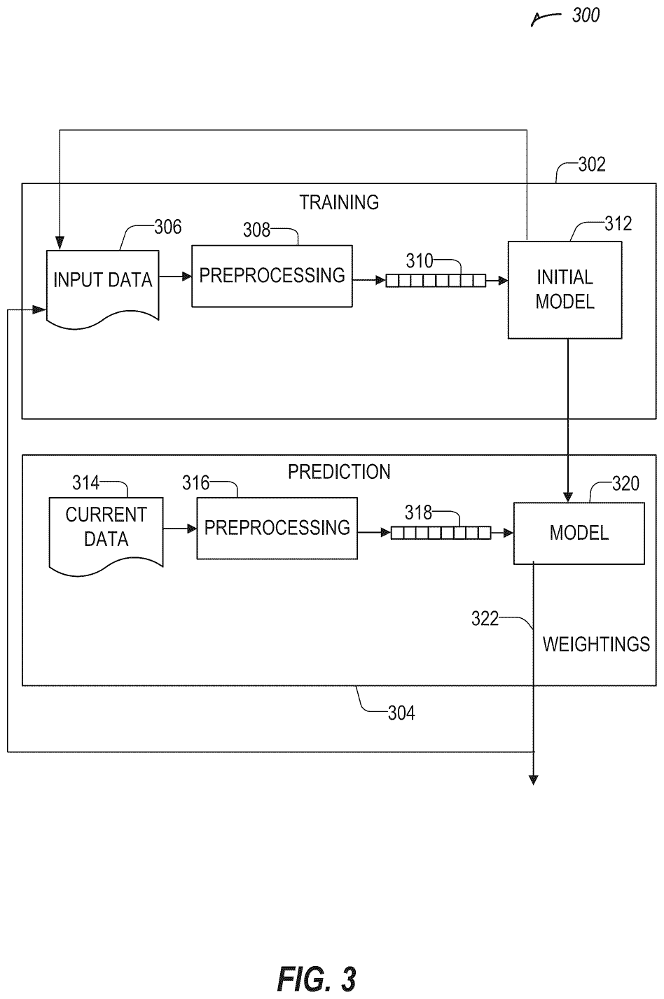

FIG. 3 illustrates a machine learning engine for training and execution related to fraud detection, according to various examples. The machine learning engine may be deployed to execute at a mobile device (e.g., a cell phone) or a computer (e.g., an orchestrator server). A system may calculate one or more weightings for criteria based upon one or more machine learning algorithms. FIG. 3 shows an example machine learning engine 300 according to some examples of the present disclosure.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include user session information, malicious session information, legitimate signatures, falsified signatures, user interactions, malicious interactions, or the like. In the prediction engine 304, current data 314 (e.g., a current session, signature, interaction, etc., which is unknown as to whether it is a legitimate user or malicious) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user or purpose.

Labels for the input data 306 may include whether a session, signature, interaction, etc. is or was legitimate or malicious.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may output a prediction as to whether a session, signature, interaction, or the like is legitimate or malicious. The model 320 may be retrained over time, in some examples.

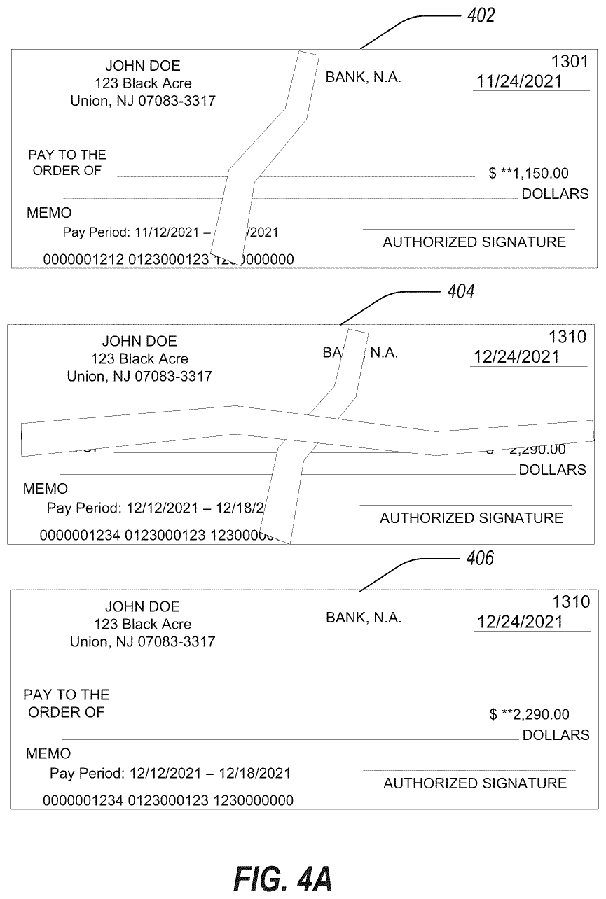

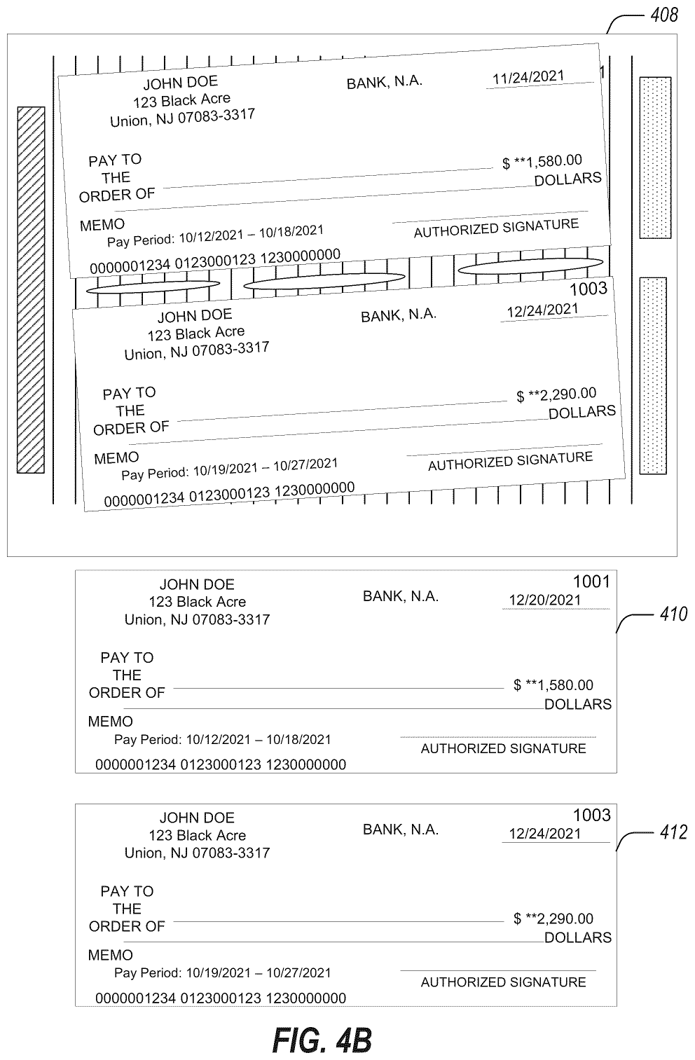

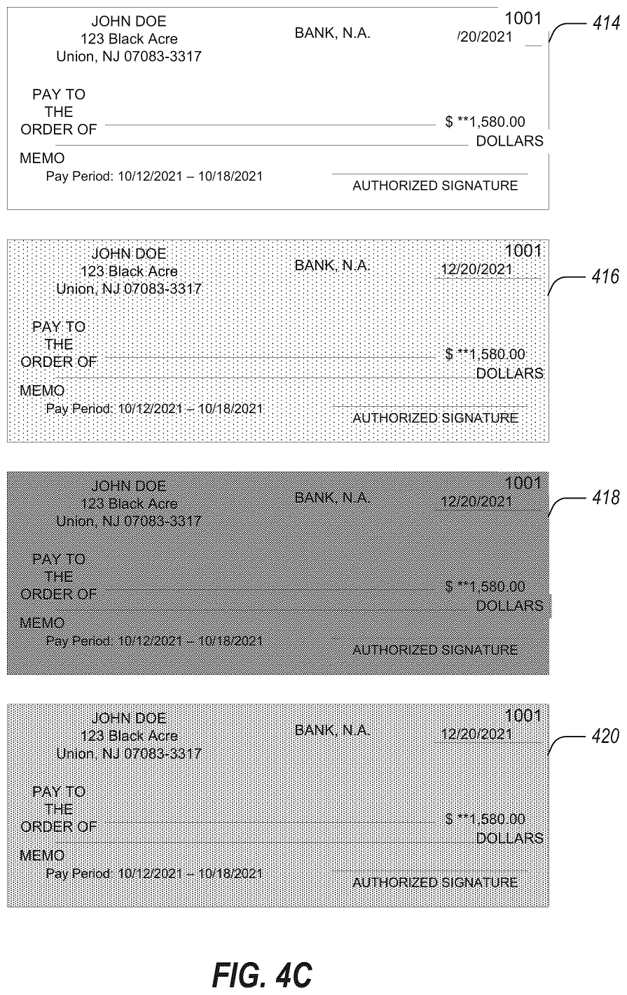

FIGS. 4A-4C illustrate example checks, according to various examples.

FIG. 4A illustrates example check images including issues that may arise with check image capture quality. These issues may affect the ability to process a check accurately and efficiently. The depicted checks include specific image quality attributes that may be monitored and assessed by an automated system. The assessment may include using computer vision, natural language processing, and machine learning to determine whether necessary information or processing a check may be extracted from the image of the check.

Issues may be identified in a check image, such as the presence of streaks or overlays as shown in checks 402 and 404, unclear or blurry text, piggyback checks, etc., For example, a piggyback check may occur when multiple checks are captured together in a single image, obscuring details. In an example, checks with extreme brightness or darkness that prevents extraction of information such as payor or payee details may be identified.

The following attributes may be used to monitor and determine whether a check image is to be recaptured or whether the check may be processed from the image.

```
{
  “format”: str,
  “resolution”: list,
  “brightness”: float,
  “undersized_image”: bool,
  “oversized_image”: bool,
  “image_too_light”: bool,
  “image_too_dark”: bool,
  “horizontal_streaks”: bool,
  “vertical_streaks”: bool,
  “folded_or_torn_corner”: bool,
  “folded_or_torn_edge”: bool,
  “excessive_skew”: bool,
  “excessive_spot_noise”: bool,
  “out_of_focus”: bool,
  “piggyback”: bool,
  “carbon_strips”: bool,
  “rotated_180”: bool,
  “flipped_front_to_back”: bool,
}
```

The attributes monitored for quality assessment may include the image format, resolution, brightness level, and various potential defects, as shown in the above code. The code specifies a set of boolean flags for attributes, any one or more of which may indicate that an image needs to be recaptured. The flags for format, resolution, and brightness may be compared to a threshold or selected attribute (e.g., a range for brightness, a type for format that is acceptable, such as one of a standard image or document formats, or a range for a resolution). Each attribute corresponds to a specific defect that may impact processing. In some examples, a combination of attributes may be required for recapture (e.g., a folded or torn corner by itself may not impact processing).

In some examples, the “horizontal streaks” and “vertical streaks” attributes may detect unwanted lines across the image that could obscure critical details, such as the amount or signature on the check. For example, check 402 with a substantially vertical streak and check 404 with a both a substantially vertical and a substantially horizontal streak may require recapture. The “out_of_focus” attribute may identify checks where text or other elements are blurred, requiring recapture.

In some examples, these attributes may be used to generate a detailed quality profile for each check image. For example, a profile may include metadata such as the image format (e.g., TIFF or JPEG), resolution (e.g., [735, 301]), or brightness (e.g., 235.80). Based on the detected attributes, a check image may be categorized as acceptable for processing or flagged for recapture.

In an example, check 402 may undergo testing and results may be indicated as:

```
{
  “format”: “TIFF”,
  “resolution”: [735, 301],
  “brightness”: 235.80,
  “undersized_image”: false,
  “oversized_image”: false,
  “image_too_light”: false,
  “image_too_dark”: false,
  “horizontal_streaks”: false,
  “vertical_streaks”: true,
  “folded_or_torn_corner”: false,
  “folded_or_torn_edge”: false,
  “excessive_skew”: false,
  “excessive_spot_noise”: false,
  “out_of_focus”: false,
  “piggyback”: false,
  “carbon_strips”: false,
  “rotated_180”: false,
  “flipped_front_to_back”: false,
}
```

In an example, check 404 may undergo testing and results may be indicated as:

```
{
  “format”: “JPEG”,
  “resolution”: [854, 294],
  “brightness”: 184,
  “undersized_image”: false,
  “oversized_image”: false,
  “image_too_light”: false,
  “image_too_dark”: false,
  “horizontal_streaks”: true,
  “vertical_streaks”: true,
  “folded_or_torn_corner”: false,
  “folded_or_torn_edge”: false,
  “excessive_skew”: false,
  “excessive_spot_noise”: false,
  “out_of_focus”: false,
  “piggyback”: false,
  “carbon_strips”: false,
  “rotated_180”: false,
  “flipped_front_to_back”: false,
}
```

Because both checks 402 and 404 include at least one flag, they may be identified as requiring recapture.

In an example, check 406 may undergo testing and results may be indicated as:

```
{
  “format”: “JPEG”,
  “resolution”: [408, 187],
  “brightness”: 135,
  “undersized_image”: false,
  “oversized_image”: false,
  “image_too_light”: false,
  “image_too_dark”: false,
  “horizontal_streaks”: false,
  “vertical_streaks”: false,
  “folded_or_torn_corner”: false,
  “folded_or_torn_edge”: false,
  “excessive_skew”: false,
  “excessive_spot_noise”: false,
  “out_of_focus”: false,
  “piggyback”: true,
  “carbon_strips”: false,
  “rotated_180”: false,
  “flipped_front_to_back”: false,
}
```

The piggyback flag is indicated for check 406 because it includes attributes of check 404, such as a same pay period, same amount, same date, same check number, etc. In some examples, check 406 may be disregarded as a duplicate, or a prompt may be output to indicate that check 406 is or may be a duplicate.

FIG. 4B illustrates an image capture of two checks containing significant background color and patterns (represented in FIG. 4B as lines, boxes, and circles, but which may include any shapes or colors in practice), which may render the checks unreadable without processing. Image 408 depicts an image capture of checks, where both checks may appear rotated or misaligned. While FIG. 4B shows the checks in a same rotation, other arbitrary rotations of checks may be processed (e.g., two checks with one substantially vertical, one skewed). Images 410 and 412 illustrate results of applying a boundary box to each check in the top image 408. After applying a boundary box, each check may be isolated and reoriented before processing the information on the checks. The image 408 includes the capture of two checks, but may include more than two, which may be processed into separate check images (e.g., image 410 and 412).

Information may be extracted from the check images 410 and 412, such as the following attributes or metadata:

```
{
  “check_type”: str,
  “payor_bank”: str,
  “payor_name”: str,
  “payor_address_1”: str,
  “payor_address_2”: str,
  “payor_phone”: str,
  “check_year”: int,
  “check_month”: int,
  “check_day”: int,
  “legal_amount”: str,
  “convenience_amount”: float,
  “serial_number”: str,
  “payee_name”: str,
  “payee_address_1”: str,
  “payee_address_2”: str,
  “payor_type”: str,
  “payee_type”: str,
}
```

The extracted information may be used to track whether a check is valid by only storing the attribute or metadata values for later comparison to a potentially fraudulent check (e.g., a stolen check image, a reattempted check cash, etc.).

FIG. 4C illustrates the same check captured four times under different lighting conditions, resulting in varying background colors in images 414, 416, 418, and 420. The images 414, 416, 418, and 420 show how lighting differences and background variations can affect the readability and detectability of the attributes of a check. In an example, the background color may be normalized to a consistent shade, such as the color shown in the topmost check 406, to ensure uniformity during processing. This normalization may facilitate more accurate attribute extraction and comparison with existing records.

Table 1 below illustrates various tasks that may be used to determine whether a check is similar to any previously processed checks, such as a check that is reproduced, reprinted, rephotographed, or rescanned. The duplicate check may be fraudulent or a result of an error (e.g., a processing error, a customer forgetting that a check was already submitted, etc.).

TABLE 1
Tasks and Models for Similar Check
Detection and Attribute Extraction

| | | | Evaluation |
|---|---|---|---|
| Task | Starter Model | Description | Metrics |
| Check Crops | YOLOv8/RT-DETR | A model that | Recall @ T |
| | | detects | T: an |
| | | bounding box | chosen |
| | | around each | threshold to |
| | | instance of | hit a |
| | | check within | minimum |
| | | an image to | precision of |
| | | crop out each | 75% |
| | | check | |
| | | instance. | |
| Check | Rapid-Orientation/ | A model that | Balanced |
| Rotation | PULC_text_image_{—} | rotates a | Accuracy |
| | orientation | cropped | Score |
| | | check image | Confusion |
| | | to the correct | Matrix |
| | | orientation. | Post- |
| | | | rotation |
| | | | Histogram |
| Check | SSCD | A model that | Precision |
| Similarity | | vectorizes a | @ T |
| | | check crop | T: an |
| | | image to help | chosen |
| | | find other | threshold to |
| | | visually | hit a |
| | | similar | minimum |
| | | checks for | recall of |
| | | deduplication. | 75% |
| Check | Donut VQA | A multimodal | Single Field |
| Understanding | | model that | Normalized |
| | | views a | Levenshtein |
| | | cropped | Distance |
| | | check image | |
| | | and its OCR | |
| | | text to | |
| | | generate the | |
| | | text attributes | |
| | | associated | |
| | | with the | |
| | | check. The | |
| | | text attributes | |
| | | may also be | |
| | | used to | |
| | | represent | |
| | | category or | |
| | | confidence | |
| | | level. | |

In an example, the tasks in Table 1 may include a task for identifying and flagging checks that are similar to those already present in a database. For example, a submitted check may be cropped (e.g., via a bounding box), undergo rotation correction, or compared to previously captured images to determine whether the submitted check matches a known compromised check or is a duplicate.

Other check related issues may be corrected for a submitted check such as a codeline mismatch, an undersized or oversized image, an image that is too light or too dark, a horizontal streak, a vertical streak, a piggyback check, a flipped front to back or back to front check, a front-back image mismatch, an invalid image format, an image resolution issue (e.g., too small), or the like. These issues may be corrected during preprocessing to ensure that checks are comparable in format, resolution, and quality, or may be indicated to require recapture.

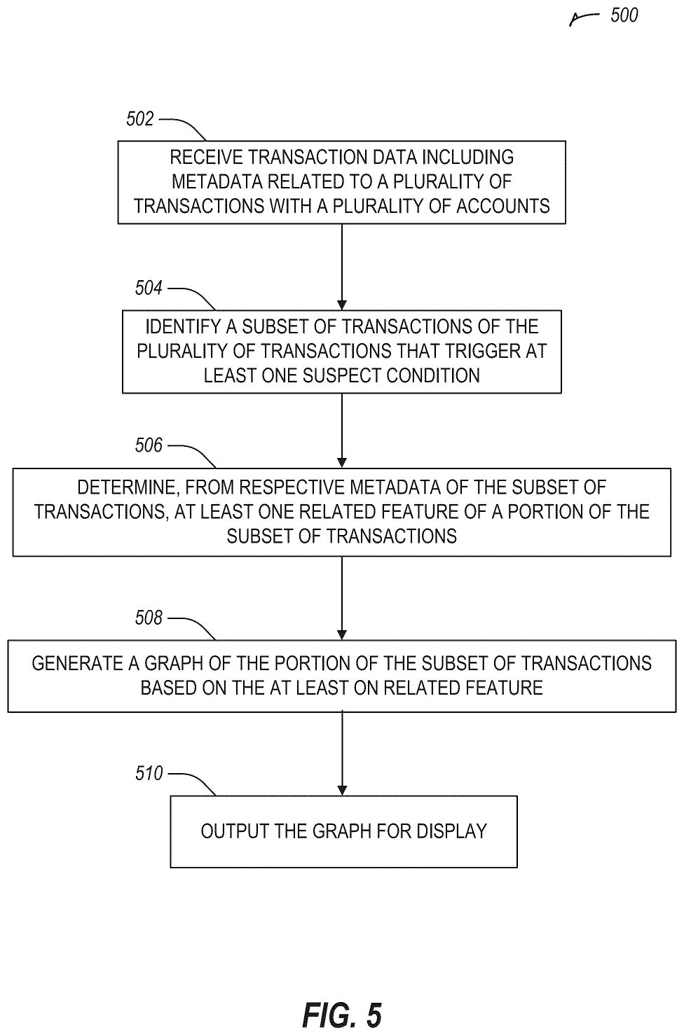

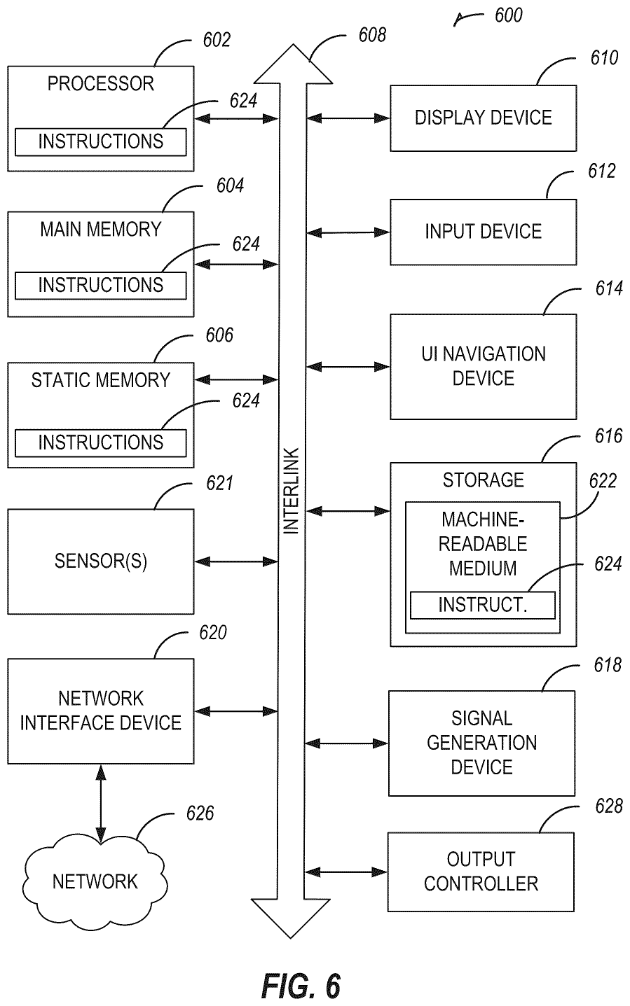

FIG. 5 illustrates a flowchart showing a technique for graph-based anomaly detection, according to various examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1 or 6.

The technique 500 includes an operation 502 to receive transaction data including metadata related to a plurality of transactions with a plurality of accounts. In some examples, the data may include timestamps, transaction amounts, recipient details, or geographic information. In another example, the metadata may correspond to a money transfer, including information about the sender, receiver, or the transaction amount. The transaction data may be collected from a banking application or a financial network, such as in real-time or as part of a batch process.

The technique 500 includes an operation 504 to identify, using the transaction data, a subset of transactions of the plurality of transactions that trigger at least one suspect condition. A suspect condition may include a transaction pattern or characteristic indicative of potential fraud or anomalous behavior. For example, a suspect condition may include a bank transfer exceeding a specified threshold amount, a lack of retail activity within a specified time frame, or the presence of a bill pay transaction without corresponding payroll deposits. Other examples of suspect conditions may include wire transfers originating from a business account, frequent high-limit transactions, or subscriptions to services such as credit monitoring.

In an example, the at least one suspect condition includes at least one of a Zelle Transfer above a threshold amount (e.g., $500), a subscription to a credit monitor service, a lack of or minimal amount of retail activity, a bill pay transaction, a lack of regular payroll transactions, a high limit transaction (e.g., a transaction above a specified threshold), a wire transfers from a business account, or the like. In an example, the technique 500 may include flagging an account for further review when the account includes multiple suspect conditions, such as a high limit credit transaction combined with a lack of retail activity.

The technique 500 includes an operation 506 to determine, from respective metadata of the subset of transactions, at least one related feature of a portion of the subset of transactions. In an example, the at least one related feature includes a zip code. The at least one related feature may include at least one of a physical address, a WFA cookie, an IP address of DDA origination, or the like. In another example, a k-nearest neighbor evaluation may be used to determine chains of connections between or among entities, such as accounts that share a common physical address or device identifier. The connections may be used to uncover a fraud network where entities appear unrelated but are linked through less obvious features, such as shared cookies or overlapping transaction times. In an example, the chains of connections include connections among entities that do not share an address, zip code, or last name.

The technique 500 includes an operation 508 to generate a graph of the portion of the subset of transactions based on the at least one related feature. The graph may identify respective accounts of the plurality of accounts corresponding to the subset of transactions. The graph may illustrate a set of entities that are related via the at least one related feature, the set of entities including at least one of customers, ATMs, bank branches, or the like. In an example, the graph may illustrate how a single customer account connects to multiple suspicious transactions across different geographic locations, indicating a potential fraud ring.

The technique 500 includes an operation 510 to output the graph for display. Nodes of the graph may include a color corresponding to a dollar amount. The graph may identify a root user linked to multiple fraud trees. In an example, the technique 500 may include detecting two distinct fraud rings that share a secondary feature, such as overlapping IP addresses, which may suggest a coordinated effort. The technique 500 may include using the graph to determine at least one root user causing at least two fraud trees within the graph, and outputting an indication of the at least one root user. The technique 500 may include determining at least two rings of fraudulent activity within the graph and determining that the at least two rings are related based on the at least one related feature or a second at least one related feature of at least one node of each of the at least two rings.

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

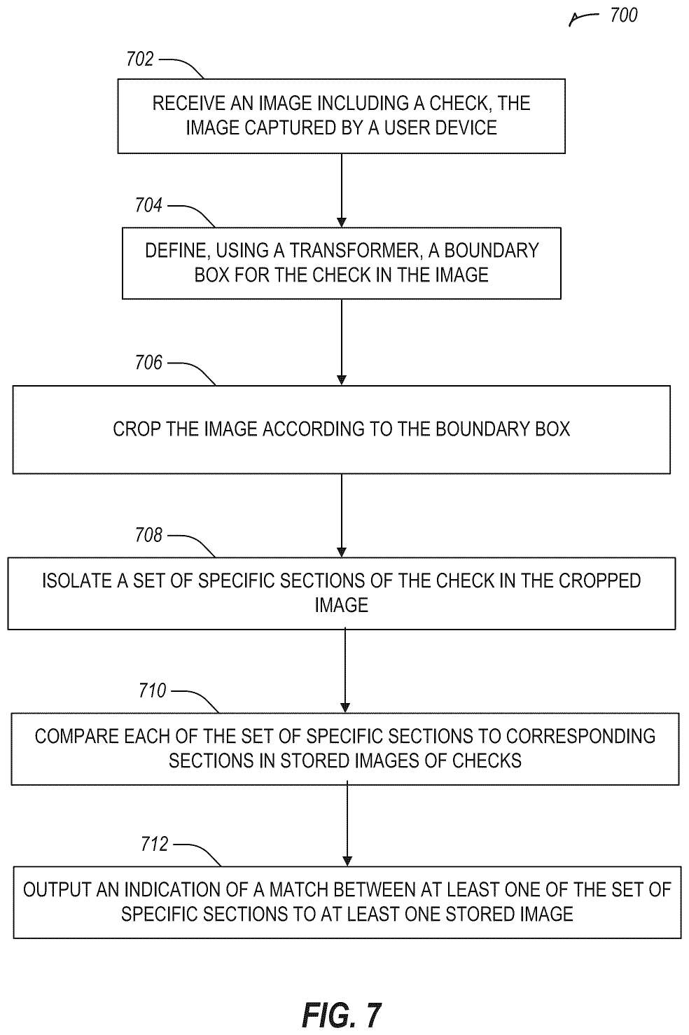

FIG. 7 illustrates a flowchart showing a technique for check fraud detection in accordance with some examples. In an example, operations of the technique 700 may be performed by processing circuitry, for example by executing instructions stored in memory. The processing circuitry may include a processor, a system on a chip, or other circuitry (e.g., wiring). For example, technique 700 may be performed by processing circuitry of a device (or one or more hardware or software components thereof), such as those illustrated and described with reference to FIG. 1 or 6.

The technique 700 includes an operation 702 to receive an image including a check, the image captured by a user device. The user device may include a smartphone, a tablet, a scanner, etc. For example, a user may capture an image of a check for remote deposit using a banking application. The image may include one or more checks placed in various orientations, with differing lighting conditions or background features.

The technique 700 includes an operation 704 to define, using a transformer, a boundary box for the check in the image. The image may include two or more checks, and operation 704 may include defining respective boundary boxes for each of the two or more checks. For example, in an image with multiple checks, the transformer may identify the boundaries of each check based on their edges and geometric features, ensuring that each instance is isolated for further processing. When an image includes overlapping checks, an indication may be output (e.g., to the user device) to recapture the image without the overlapping.

The technique 700 includes an operation 706 to crop the image according to the boundary box. Cropping may remove unnecessary background details, such as a table surface, a shadow, a user's hand, etc. For example, a check placed at an angle may be cropped and aligned to a selected orientation, making subsequent analysis more accurate.

The technique 700 includes an operation 708 to isolate a set of specific sections of the check in the cropped image. The set of specific sections of the check may include at least one of a signature section, a MICR line section, a date, a numerical value section, a written value section, or the like. For example, the MICR line section may include encoded information such as the account number and routing number.

The technique 700 includes an operation 710 to compare each of the set of specific sections to corresponding sections in stored images of checks. For example, the MICR line from the current check may be compared to historical data to confirm that the account information matches a legitimate record. The signature section may be cross-referenced against stored signature samples to detect inconsistencies, such as variations in handwriting or forgery attempts.

The technique 700 includes an operation 712 to output an indication of a match between at least one of the set of specific sections to at least one stored image. In an example, the check is a fraudulent check, and in this example operation 712 may include flagging the at least one stored image as potentially fraudulent. In another example, operation 712 may include outputting an indication that the check is potentially fraudulent based on identification of the at least one stored image corresponding to a fraudulent check. In yet another example, operation 712 may include providing a confirmation that the check matches a valid record, allowing it to proceed through a transaction workflow.

The technique 700 may include normalizing the cropped image for color. The technique 700 may include normalizing the cropped image for text size or font. For example, normalizing color may correct for lighting inconsistencies in the original image, ensuring uniform analysis across all checks or as compared to a saved image. Adjusting text size and font may improve the accuracy of optical character recognition (OCR) used to extract information from the written value field or other textual sections.

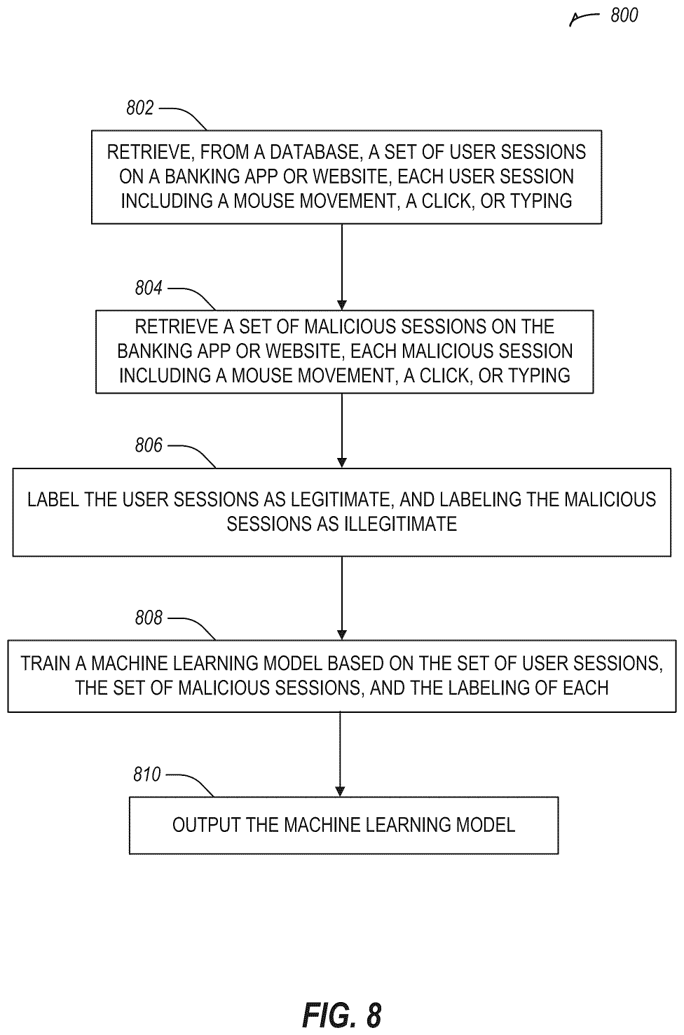

FIG. 8 illustrates a flowchart showing a technique for banking session fraud detection in accordance with some examples. In an example, operations of the technique 800 may be performed by processing circuitry, for example by executing instructions stored in memory. The processing circuitry may include a processor, a system on a chip, or other circuitry (e.g., wiring). For example, technique 800 may be performed by processing circuitry of a device (or one or more hardware or software components thereof), such as those illustrated and described with reference to FIG. 1 or 6.

The technique 800 includes an operation 802 to retrieve, from a database, a set of user sessions on a banking app or website, each user session including a mouse movement, a click, or typing. Each user session may include detailed information about interactions on a banking app or website, such as mouse movements, clicks, or typing patterns. For example, a user session may capture how a legitimate user navigates through the website, types a password, or clicks on a transaction button. These data points may serve as a baseline for distinguishing normal behavior from suspicious activity.

The technique 800 includes an operation 804 to retrieve a set of malicious sessions on the banking app or website, each malicious session including a mouse movement, a click, or typing. These sessions may represent known cases of unauthorized access or fraudulent activity. For example, a malicious session may include erratic mouse movements, rapid copying and pasting of information, or unusual typing patterns that differ from the legitimate user's behavior. These data points may be collected from previously flagged sessions or simulated to reflect common fraud techniques, such as credential stuffing or automated bot attacks.

The technique 800 includes an operation 806 to label the user sessions as legitimate, and labeling the malicious sessions as illegitimate. This labeling may be used to train a machine learning model. For example, the labeling may include tagging sessions that demonstrate normal user interactions as legitimate, while sessions involving unusual navigation or rapid form filling are tagged as illegitimate. The labeled data may include examples of elder fraud, such as sessions initiated through phishing emails or fraudulent calls aimed at extracting personal information from older users.

The technique 800 includes an operation 808 to train a machine learning model based on the set of user sessions, the set of malicious sessions, and the labeling of each. The training process may include supervised learning to associate specific behaviors with the session labels.

The technique 800 includes an operation 810 to output the machine learning model. In an example, a malicious session of the set of malicious sessions includes an unauthorized access to the banking app or website based on elder fraud using a phishing text, a phishing call, or a phishing email. The model may be used to analyze new user sessions in real time, identifying potentially fraudulent activity based on learned patterns. For example, when a new session displays characteristics similar to those of malicious sessions, the model may output an alert. The alert may indicate that the session is to be flagged for further review or trigger an automated security measure, such as requiring multi-factor authentication.

The technique 800 may include retraining or updating the machine learning model using additional user sessions or additional malicious sessions. Retraining or updating may be used to adapt the model to new fraud techniques or changes in user behavior over time. This iterative process may ensure that the model remains effective in detecting fraud in dynamic environments.

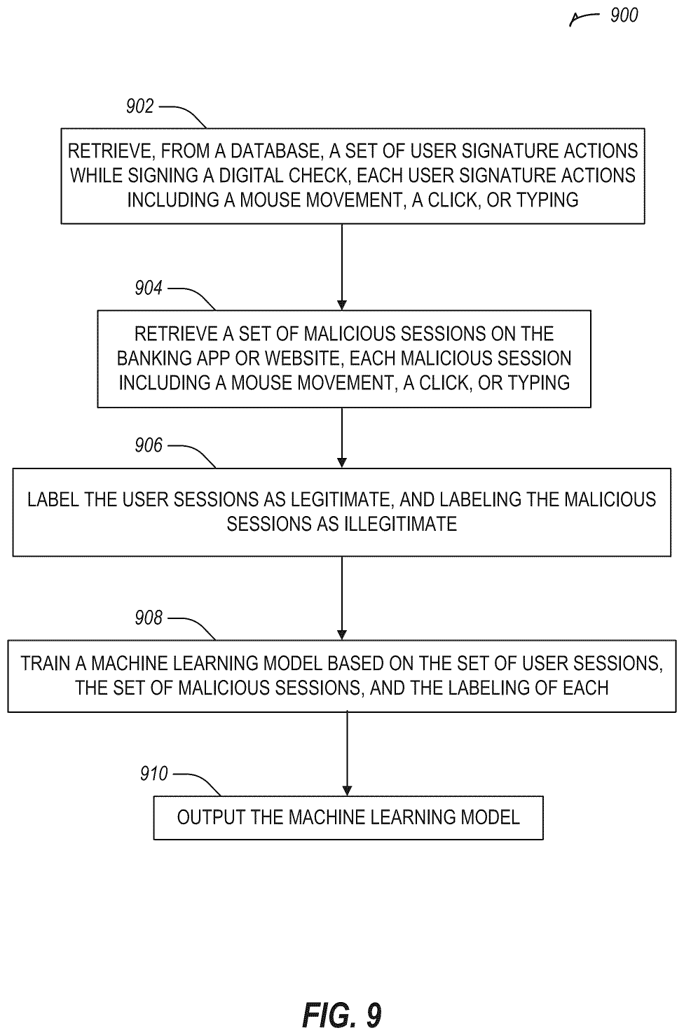

FIG. 9 illustrates a flowchart showing a technique for digital check signature fraud detection in accordance with some examples. In an example, operations of the technique 900 may be performed by processing circuitry, for example by executing instructions stored in memory. The processing circuitry may include a processor, a system on a chip, or other circuitry (e.g., wiring). For example, technique 900 may be performed by processing circuitry of a device (or one or more hardware or software components thereof), such as those illustrated and described with reference to FIG. 1 or 6.

The technique 900 includes an operation 902 to retrieve, from a database, a set of user signature actions while signing a digital check, each user signature actions including a mouse movement, a click, or typing. The user signature actions may be checked to determine whether they are legitimate, for example consistent, fluid mouse movements when creating a signature or entering additional check details. The signature actions may be used as a baseline for distinguishing normal behaviors from fraudulent actions.

The technique 900 includes an operation 904 to retrieve a set of malicious sessions on a banking app or website, each malicious session including a mouse movement, a click, or typing. The malicious sessions may represent known instances of fraudulent activity, such as those involving attempts to forge a digital signature or misuse a compromised account. For example, a malicious session may display erratic mouse movements, abrupt pauses, or unusually fast signing actions, which may indicate the use of automated tools.

The technique 900 includes an operation 906 to label the user sessions as legitimate, and labeling the malicious sessions as illegitimate. Labeling the user sessions may include tagging sessions that include typical user behavior during a signing event as legitimate, and labeling sessions having suspicious patterns as fraudulent. For example, sessions with consistent and natural mouse trajectories may be considered legitimate, whereas those with abrupt changes in movement or inconsistencies in click timing may be flagged as illegitimate. This labeling step may create a dataset for training a machine learning model.

The technique 900 includes an operation 908 to train a machine learning model based on the set of user sessions, the set of malicious sessions, and the labeling of each.

The technique 900 includes an operation 910 to output the machine learning model. The model may analyze new user sessions in real time to determine whether they are legitimate or fraudulent. For example, during a digital signing event, the model may evaluate a signature trajectory and interaction patterns to determine whether the session is legitimate or fraudulent. When the session is determined by the model to be fraudulent or potentially fraudulent, the model may output an indication to trigger a security measure, such as flagging the transaction for review or terminating the session.

In some examples, the operation 910 may include retraining or updating the machine learning model using additional user sessions or additional malicious sessions. This iterative process may be used to improve the model's ability to adapt to evolving fraud techniques or changes in user behavior. In an example, a malicious session of the set of malicious sessions includes an unauthorized access to the banking app or website based on elder fraud using a phishing text, a phishing call, or a phishing email.

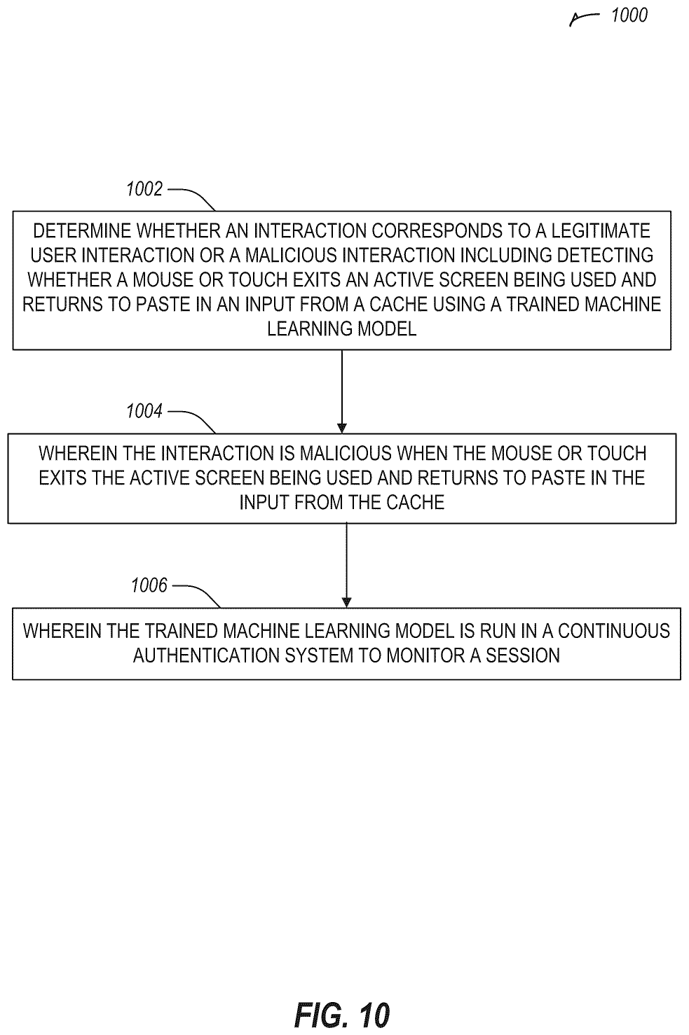

FIG. 10 illustrates a flowchart showing a technique 1000 for digital check signature fraud detection in accordance with some examples. In an example, operations of the technique 1000 may be performed by processing circuitry, for example by executing instructions stored in memory. The processing circuitry may include a processor, a system on a chip, or other circuitry (e.g., wiring). For example, technique 1000 may be performed by processing circuitry of a device (or one or more hardware or software components thereof), such as those illustrated and described with reference to FIG. 1 or 6.

The technique 1000 includes using a trained machine learning model to determine whether an interaction corresponds to a legitimate user interaction or a malicious interaction. The trained model may analyze user behaviors during a session, such as mouse movements or touch gestures, to identify patterns associated with fraud. The model may operate in real time, evaluating each interaction against learned characteristics of legitimate and malicious behaviors.

The technique 1000 includes an operation 1002 to determine whether the interaction corresponds to the legitimate user interaction or the malicious interaction. This operation may include detecting whether a mouse or touch exits an active screen being used and returns to paste in an input from a cache. Such an exit and return may indicate an attempt to bypass a manual input process, such as by copying and pasting pre-prepared fraudulent information into a form. For example, during a digital check signing session, when a user exits a signing interface to retrieve data from an external source, this action may be flagged as suspicious.

The technique 1000 includes an operation 1004 to identify the interaction as malicious when the mouse or touch exits the active screen being used and returns to paste in the input from the cache. For example, when a user pastes a pre-generated signature or account number after returning to a screen, the technique 1000 may determine that the interaction does not align with typical user behavior. In some examples, this determination may rely on the trained machine learning model's ability to differentiate legitimate navigation patterns from fraudulent activities designed to exploit system vulnerabilities.

The technique 1000 includes an operation 1006 to run the trained machine learning model in a continuous authentication system to monitor a user session. The model may monitor user interactions throughout the user session. For example, when a user's behavior shifts from legitimate actions, such as fluid mouse movements, to suspicious actions like frequent screen exits and data pasting, the model determine that the user session has become suspect. This approach may allow for dynamic detection of fraud as it occurs.

When an interaction is classified as malicious, the technique 1000 may include ending the session associated with the interaction. For example, when a fraudulent signature is detected during a digital check signing process, the session may be terminated to prevent execution or cashing of the digital check. In some examples, an alert may be output to the user or a banking institution, such as providing details about the suspicious behavior for further review.

The following, non-limiting examples, detail certain aspects of the present subject matter to solve the challenges and provide the benefits discussed herein, among others.

Example 1 is a method for graph-based anomaly detection, the method comprising: receiving transaction data including metadata related to a plurality of transactions with a plurality of accounts; identifying a subset of transactions of the plurality of transactions that trigger at least one suspect condition; determining, from respective metadata of the subset of transactions, at least one related feature of a portion of the subset of transactions; generating a graph of the portion of the subset of transactions based on the at least on related feature; and outputting the graph for display.

In Example 2, the subject matter of Example 1 includes, wherein the at least one related feature includes a zip code.

In Example 3, the subject matter of Examples 1-2 includes, wherein the graph illustrates a set of entities that are related via the at least one related feature, the set of entities including at least one of customers, ATMs, bank branches, or the like.

In Example 4, the subject matter of Examples 1-3 includes, wherein determining the at least one related feature includes using a k-nearest neighbor evaluation to determine chains of connections among the subset of transactions.

In Example 5, the subject matter of Example 4 includes, wherein the chains of connections include connections among entities that do not share an address, zip code, or last name.

In Example 6, the subject matter of Examples 1-5 includes, using the graph to determine at least one root user causing at least two fraud trees within the graph, and outputting an indication of the at least one root user.

In II Example 7, the subject matter of Examples 1-6 includes, wherein the at least one related feature includes at least one of a physical address, a WFA cookie, an IP address of DDA origination, or the like.

In Example 8, the subject matter of Examples 1-7 includes, wherein the at least one suspect condition includes at least one of a Zelle Transfer above a threshold amount (e.g., $500), a subscription to a credit monitor service, a lack of or minimal amount of retail activity, a bill pay transaction, a lack of regular payroll transactions, a high limit transaction (e.g., a transaction above a specified threshold), a wire transfers from a business account, or the like.

In Example 9, the subject matter of Examples 1-8 includes, wherein nodes of the graph include a color corresponding to a dollar amount.

In Example 10, the subject matter of Examples 1-9 includes, determining at least two rings of fraudulent activity within the graph and determining that the at least two rings are related based on the at least one related feature or a second at least one related feature of at least one node of each of the at least two rings.

Example 11 is a method for check fraud detection, the method comprising: receiving an image including a check, the image captured by a user device; defining, using a transformer, a boundary box for the check in the image; cropping the image according to the boundary box; isolating a set of specific sections of the check in the cropped image; comparing each of the set of specific sections to corresponding sections in stored images of checks; and outputting an indication of a match between at least one of the set of specific sections to at least one stored image.

In Example 12, the subject matter of Example 11 includes, wherein the image includes two or more checks, and wherein defining the boundary box includes defining respective boundary boxes for each of the two or more checks.

In Example 13, the subject matter of Examples 11-12 includes, wherein the check is a fraudulent check, and wherein outputting the indication of the match includes flagging the at least one stored image as potentially fraudulent.

In Example 14, the subject matter of Examples 11-13 includes, wherein outputting the indication of the match includes outputting an indication that the check is potentially fraudulent based on identification of the at least one stored image corresponding to a fraudulent check.

In Example 15, the subject matter of Examples 11-14 includes, normalizing the cropped image for color.

In Example 16, the subject matter of Examples 11-15 includes, normalizing the cropped image for text size or font.

In Example 17, the subject matter of Examples 11-16 includes, wherein the set of specific sections includes at least one of a signature section, a MICR line section, a date, a numerical value section, a written value section, or the like.

Example 18 is a method for banking session fraud detection, the method comprising: retrieving, from a database, a set of user sessions on a banking app or website, each user session including a mouse movement, a click, or typing; retrieving a set of malicious sessions on the banking app or website, each malicious session including a mouse movement, a click, or typing; labeling the user sessions as legitimate, and labeling the malicious sessions as illegitimate; training a machine learning model based on the set of user sessions, the set of malicious sessions, and the labeling of each; outputting the machine learning model.

In Example 19, the subject matter of Example 18 includes, retraining or updating the machine learning model using additional user sessions or additional malicious sessions.

In Example 20, the subject matter of Examples 18-19 includes, wherein a malicious session of the set of malicious sessions includes an unauthorized access to the banking app or website based on elder fraud using a phishing text, a phishing call, or a phishing email.

Example 21 is a method for digital check signature fraud detection, the method comprising: retrieving, from a database, a set of user signature actions while signing a digital check, each user signature actions including a mouse movement, a click, or typing; retrieving a set of malicious signature actions while signing a digital check, each malicious signature actions including a mouse movement, a click, or typing; labeling the user signature actions as legitimate, and labeling the malicious signature actions as illegitimate; training a machine learning model based on the set of user signature actions, the set of malicious signature actions, and the labeling of each; outputting the machine learning model.

In Example 22, the subject matter of Example 21 includes, retraining or updating the machine learning model using additional user signature actions or additional malicious signature actions.

In Example 23, the subject matter of Examples 21-22 includes, wherein the machine learning model is configured to identify a fraudulent transaction based on movement of a mouse or a touch on a touch device during a digital signature action.

Example 24 is a method for digital check signature fraud detection, the method comprising: using a trained machine learning model to determine whether an interaction corresponds to a legitimate user interaction or a malicious interaction by: determining whether the interaction corresponds to the legitimate user interaction or the malicious interaction includes, detecting whether a mouse or touch exits an active screen being used and returns to paste in an input from a cache; and wherein the interaction is malicious when the mouse or touch exits the active screen being used and returns to paste in the input from the cache; and wherein the trained machine learning model is run in a continuous authentication system to monitor a session.

In Example 25, the subject matter of Example 24 includes, wherein when the interaction is malicious, ending a session corresponding to the interaction.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for graph-based anomaly detection, the method comprising:
receiving transaction data including metadata related to a plurality of transactions with a plurality of accounts;
identifying, using the transaction data, a subset of transactions of the plurality of transactions that trigger at least one suspect condition;
determining, from respective metadata of the subset of transactions, at least one related feature of a portion of the subset of transactions;
generating a graph of the portion of the subset of transactions based on the at least one related feature, the graph identifying respective accounts of the plurality of accounts corresponding to the subset of transactions; and
outputting the graph for display.

2. The method of claim 1, wherein the at least one related feature includes a zip code.

3. The method of claim 1, wherein the graph illustrates a set of entities that are related via the at least one related feature, the set of entities including at least one of customers, ATMs, bank branches.

4. The method of claim 1, wherein determining the at least one related feature includes using a k-nearest neighbor evaluation to determine at least one chain of connection among the subset of transactions.

5. The method of claim 4, wherein the at least one chain of connection includes a connection among entities that do not share an address, zip code, or last name.

6. The method of claim 1, further comprising using the graph to determine at least one root user causing at least two fraud trees within the graph, and outputting an indication of the at least one root user.

7. The method of claim 1, wherein the at least one related feature includes at least one of a physical address, a WFA cookie, or an IP address of DDA origination.

8. The method of claim 1, wherein the at least one suspect condition includes at least one of a money transfer above a threshold amount, a subscription to a credit monitor service, a lack of retail activity, a bill pay transaction, or a wire transfers from a business account.

9. The method of claim 1, wherein nodes of the graph include a color corresponding to a dollar amount.

10. The method of claim 1, further comprising determining at least two rings of fraudulent activity within the graph and determining that the at least two rings are related based on a feature of a node connected to both of the at least two rings.

11. At least one non-transitory machine-readable medium, including instructions for graph-based anomaly detection, which when executed by processing circuitry, cause the processing circuitry to perform operations comprising:
receiving transaction data including metadata related to a plurality of transactions with a plurality of accounts;
identifying, using the transaction data, a subset of transactions of the plurality of transactions that trigger at least one suspect condition;
determining, from respective metadata of the subset of transactions, at least one related feature of a portion of the subset of transactions;
generating a graph of the portion of the subset of transactions based on the at least one related feature, the graph identifying respective accounts of the plurality of accounts corresponding to the subset of transactions; and
outputting the graph for display.

12. The at least one non-transitory machine-readable medium of claim 11, wherein the at least one related feature includes a zip code.

13. The at least one non-transitory machine-readable medium of claim 11, wherein the graph illustrates a set of entities that are related via the at least one related feature, the set of entities including at least one of customers, ATMs, bank branches.

14. The at least one non-transitory machine-readable medium of claim 11, wherein determining the at least one related feature includes using a k-nearest neighbor evaluation to determine at least one chain of connection among the subset of transactions.

15. The at least one non-transitory machine-readable medium of claim 14, wherein the at least one chain of connection includes a connection among entities that do not share an address, zip code, or last name.

16. The at least one non-transitory machine-readable medium of claim 11, wherein the instructions further cause the processing circuitry to perform operations comprising using the graph to determine at least one root user causing at least two fraud trees within the graph, and outputting an indication of the at least one root user.

17. The at least one non-transitory machine-readable medium of claim 11, wherein the at least one related feature includes at least one of a physical address, a WFA cookie, or an IP address of DDA origination.

18. The at least one non-transitory machine-readable medium of claim 11, wherein the at least one suspect condition includes at least one of a money transfer above a threshold amount, a subscription to a credit monitor service, a lack of retail activity, a bill pay transaction, or a wire transfers from a business account.

19. The at least one non-transitory machine-readable medium of claim 11, wherein nodes of the graph include a color corresponding to a dollar amount.

20. The at least one non-transitory machine-readable medium of claim 11, wherein the instructions further cause the processing circuitry to perform operations comprising determining at least two rings of fraudulent activity within the graph and determining that the at least two rings are related based on a feature of a node connected to both of the at least two rings.
